(19) United States
(12) Patent Application Publication
(10) Pub. No.: US 2007/0240057 A1
(43) Pub. Date: Oct. 11, 2007

(54) User interface element for displaying contextual information

(75) Inventors: Jesse Clay Satterfield, Seattle, WA (US); Christopher T. Pearo, Seattle, WA (US); Jensen M. Harris, Seattle, WA (US); Rodrigo Tarrats, Snoqualmie, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/402,299

(22) Filed: Apr. 11, 2006

(51) Int. Cl. G06F 9/00

(52) U.S. Cl. 715/705; 715/764; 715/810; 715/835

(57) ABSTRACT

A user interface element is provided near a focused-on button or control for providing an identification of an associated functionality and for providing display space for additional content such as help information and explanatory information related to the associated functionality.

### BACKGROUND

It is a common practice in many software application user interfaces to display a textual label near an unlabeled button or control for identifying the button or control when it is focused on, for example, when a mouse pointer is hovered over the button or control. For example, if a user hovers a mouse pointer over a print button in a user interface toolbar where the print button is only identified by an icon shaped like a printer, a small display frame may be deployed near the pointer that displays the word “print” for identifying to a user that the focused-on button is associated with a print function. Often the displayed text does not adequately identify the underlying function associated with the button or control, and the user must actually select the button or control to learn more about the underlying functionality. Often a given functionality has been disabled from use. In such cases, the pop-up display frame does not provide information as to why the functionality is disabled or as to the conditions under which the functionality may be enabled for use. In addition, such pop-up display frames do not provide help content associated with the underlying functionality, nor do such pop-up display frames provide links or connections to help content associated with the underlying functionality.

It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing a user interface element near a focused-on button or control for providing an identification of an associated functionality and for providing display space for additional content such as help information and explanatory information related to the associated functionality. These and other features and advantages will be apparent from a reading of the following detailed description and a review of the associated drawings. It is to be understood that both the foregoing general description and the following detailed description are explanatory only and are not restrictive of the invention as claimed.

### BRIEF DESCRIPTION OF THE DRAWINGS

FIG. 1 illustrates an exemplary computing operating environment.

FIG. 2A is a simplified illustration of a user interface element for displaying contextual information near a focused-on user interface button or control.

FIG. 2B is a simplified illustration of a user interface element for displaying contextual information near a focused-on user interface button or control and showing example information associated with a spreadsheet Fill function.

FIG. 3 illustrates the user interface element of FIG. 2 displayed near a focused-on button in an illustrative software application user interface.

### DETAILED DESCRIPTION

As briefly described above, embodiments of the present invention are directed to a user interface element for deployment near a focused-on button or control for providing helpful contextual information about an underlying functionality associated with the focused-on button or control. In the following detailed description, references are made to the accompanying drawings that form a part hereof, and in which are shown by way of illustrations specific embodiments or examples. These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents.

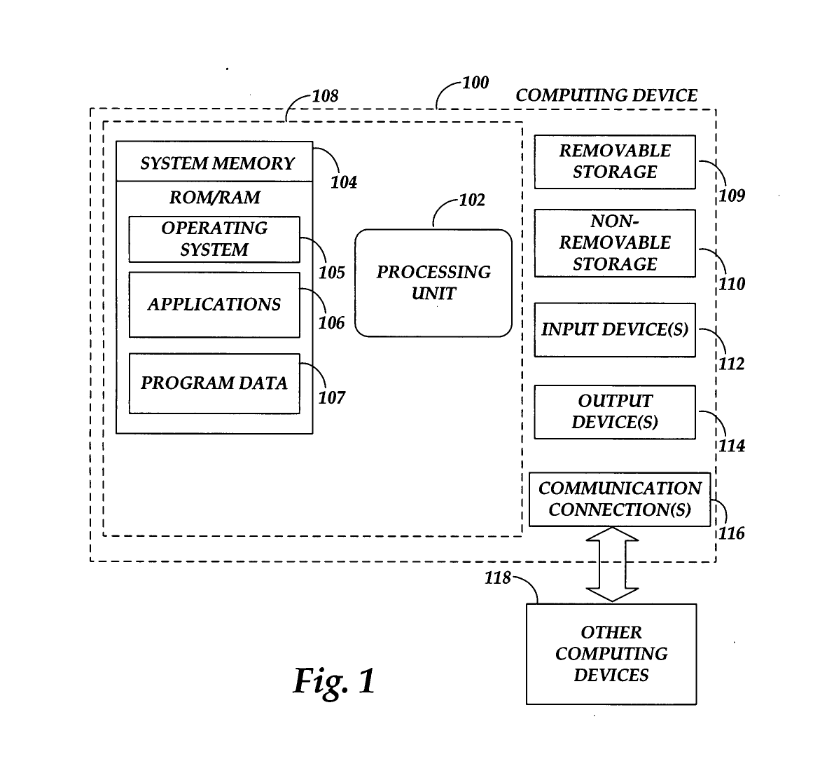

Referring now to the drawings, in which like numerals refer to like elements through the several figures, aspects of the present invention and an exemplary computing operating environment will be described. FIG. 1 and the following discussion are intended to provide a brief, general description of a suitable computing environment in which the invention may be implemented. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Embodiments of the invention may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

With reference to FIG. 1, one exemplary system for implementing the invention includes a computing device, such as computing device 100. In a basic configuration, the computing device 100 typically includes at least one processing unit 102 and system memory 104. Depending on the exact configuration and type of computing device, the system memory 104 may be volatile (such as RAM), non-volatile (such as ROM, flash memory, etc.) or some combination of the two. System memory 104 typically includes an operating system 105 suitable for controlling the operation of a networked personal computer, such as the WINDOWS® operating systems from MICROSOFT CORPORATION of Redmond, Wash. The system memory 104 may also include one or more software applications 106 and may include program data 107. This basic configuration is illustrated in FIG. 1 by those components within dashed line 108.

According to embodiments of the invention, the application 106 may comprise many types of software applications, such as an electronic mail program, a calendaring program, an Internet browsing program, and the like. An example of such programs is OUTLOOK® manufactured by MICROSOFT CORPORATION. The application 106 may include a number of other types software applications including a multiple-functionality software application for providing many other types of functionalities. Such a multiple-functionality application may include a number of program modules, such as a word processing program, a spreadsheet program, a slide presentation program, a database program, and the like. An example of such a multiple-functionality application is OFFICE™ manufactured by MICROSOFT CORPORATION. According to embodiments of the present invention, the application 106 is illustrative of any software application operable for requesting the opening of a server file or local copy of a server file according to embodiments of the invention described herein.

The computing device 100 may have additional features or functionality. For example, the computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. These devices are well known in the art and need not be discussed at length here.

The computing device 100 may also contain communication connections 116 that allow the device to communicate with other computing devices 118, such as over a network in a distributed computing environment, for example, an intranet or the Internet. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

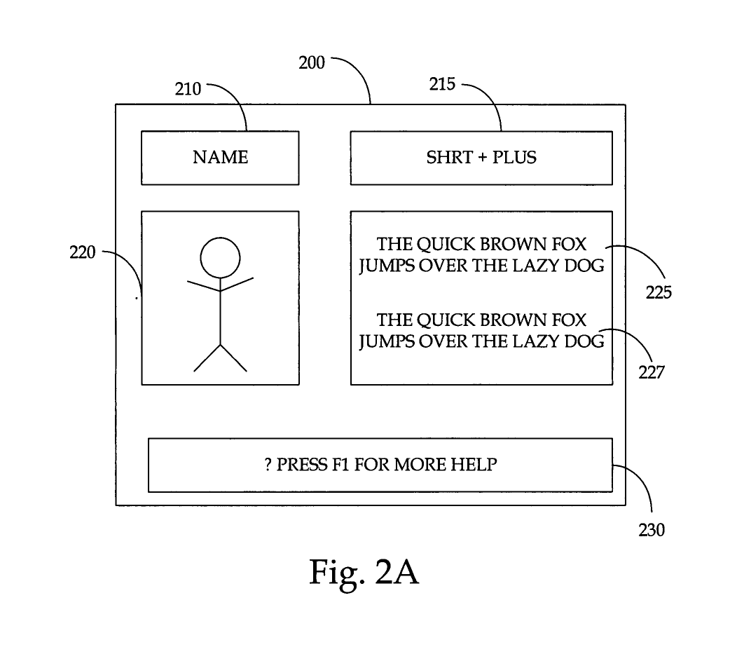

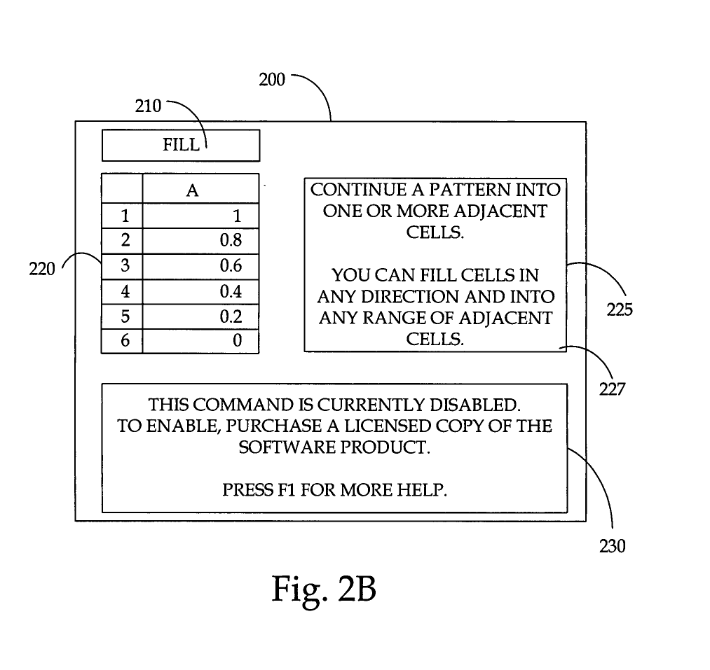

FIG. 2 is a simplified illustration of a user interface element for displaying contextual information near a focused-on user interface button or control. According to embodiments, the user interface element 200 includes a display frame or display space for providing contextually relevant information about the focused-on user interface button or control. The element 200 is deployed near a focused-on button or control in a software application user interface for providing helpful contextual information about the functionality associated with the focused-on button or control. The user interface element 200 may provide identification information for a functionality associated with the focused-on button or control, may provide graphical or descriptive information about the underlying functionality, may provide links to help content related to the associated functionality, may provide explanatory information regarding disabled functionalities, and may provide identification information regarding a functionality provided by a third-party add-in application or software module.

Referring still to FIG. 2, the user interface element 200 includes a title field or section 210 in which is displayed a title or name of the functionality associated with the focused-on button or control. For example, if the focused-on button or control is associated with a print function, the title section 210 may include a text string such as “print.” According to one embodiment, the name of the associated functionality may appear according to a variety of fonts and sizes, for example, boldface, to distinguish the name of the functionality from other content displayed in the user interface element 200. Alternatively, if no other information is displayed in the user interface element 200, a different font or display characteristic may be utilized, for example, no boldfacing.

A keyboard shortcut field or section 215 is provided for displaying a text string identifying a keyboard shortcut that may be utilized for automatically invoking the associated functionality. For example, a keyboard shortcut of “CTRL+P” may be listed in the keyboard shortcut section 215 for alerting a user of a keyboard shortcut that may be utilized for automatically invoking the desired functionality, for example, the print function. If desired, the text string comprising the keyboard shortcut may be displayed according to a variety of fonts and sizes, for example, boldfacing, to distinguish the keyboard shortcut from other information displayed in the user interface element 200. The keyboard shortcut may be positioned in the user interface element according to a number of orientations. According to one embodiment, the positioning of the keyboard shortcut may include at least an 8-pixel separation from the upper-right corner of the user interface element 200.

Referring still to FIG. 2, a bitmap image field or section 220 may be displayed in the user interface element 200 for providing contextual information about the functionality associated with the focused-on button or control. According to one embodiment, the bitmap image is only displayed when associated description information 225 is present. The optional bitmap image 220 may be displayed according to a variety of sizes, and according to one embodiment, the bitmap image size may be 96×128 pixels. The bitmap image 220 may be utilized for describing the functionality associated with the focused-on button or control. For example, if the focused-on button or control is associated with a functionality for automatically formatting a document according to a set of prescribed formatting properties, for example, centered text, the bitmap image 220 may provide a descriptive image, for example, an image of centered text, for further describing the functionality associated with the focused-on button or control. Referring to FIG. 2B, an image 220 is illustrated showing an example spreadsheet for graphically explaining how a spreadsheet cell Fill command may be used for filling spreadsheet cells with data.

According to an embodiment, a description display field or section 225 may be provided in the user interface element 200 for providing descriptive information about the functionality associated with the focused-on button or control. For example, if the focused-on button or control is associated with a print function, the descriptive information 225 may provide descriptive information, for example, “The print function may be selected for printing a displayed document according to a variety of selected print properties.” For another example, referring to FIG. 2B, a textual statement is provided in the description section 225 to explain how a spreadsheet cell Fill function may be used to fill data into an example spreadsheet.

According to embodiments, the text provided in the description section may be aligned according to different alignment properties, for example, aligned left. Where a language type requires, the text may be aligned according to an alternate alignment property, for example, aligned right. According to one embodiment, a character limit, for example, 500 characters, may be imposed on the description section of the user interface element 200.

Referring still to FIG. 2, a footer field or section 230 is illustrated for providing additional functionality including commands for selectively retrieving help content related to the functionality associated with the focused-on button or control. For example, a text string/command such as “Press F1 for more help” may be provided in the footer section 230. Selection of the command provided in the footer section 230 may cause additional help content to be retrieved and displayed in footer section 230. Selection of such a command may also cause additional descriptive content to be displayed in the description section 225, described above. As should be appreciated, any number of commands may be provided in the footer section 230 for selectively retrieving additional functionality that may be helpful to a user focusing on a given user interface button or control. For example, selectable commands may be provided in the footer field 230 for invoking any number of functionalities bearing some relation to the focused-on button or control.

In addition to selectable commands and help content, other helpful information may be provided in the footer section 230. For example, if the functionality associated with the focused-on button or control has been provided by a third-party add-in application, the description information 225 may provide identifying information about the third-party application add-in provider including help content regarding use of the third-party application add-in functionality.

If a focused-on button or control has been disabled from use, information may be provided in the footer section 230 as to why the function is disabled and how the function may be enabled. For example, a network administrator may have determined that a given functionality should not be available to certain persons utilizing the network. For another example, a particular functionality, for example, a save functionality, may not be presently available because a document in its present state has been previously saved and no additional changes have been made since the last save. Where a given functionality is presently disabled, or is otherwise not available for use, often an icon representing the functionality or a text string representing the functionality on a selectable button or control may be “grayed out” to indicate that the associated functionality has been disabled. Often, a user may recognize that the functionality has been disabled, but the user may nonetheless not understand or otherwise appreciate why the functionality has been disabled. If a disabled functionality button or control is focused on, a text string explaining why the functionality is disabled and/or providing helpful information as to how to enable use of the associated functionality may be provided in the footer section 230. For example, referring to FIG. 2B, upon focusing on an example spreadsheet cell Fill command that is presently disabled, information may be provided in the footer section 230 that informs the user of the disabled nature of the command and provides the user helpful information about how to enable the disabled command.

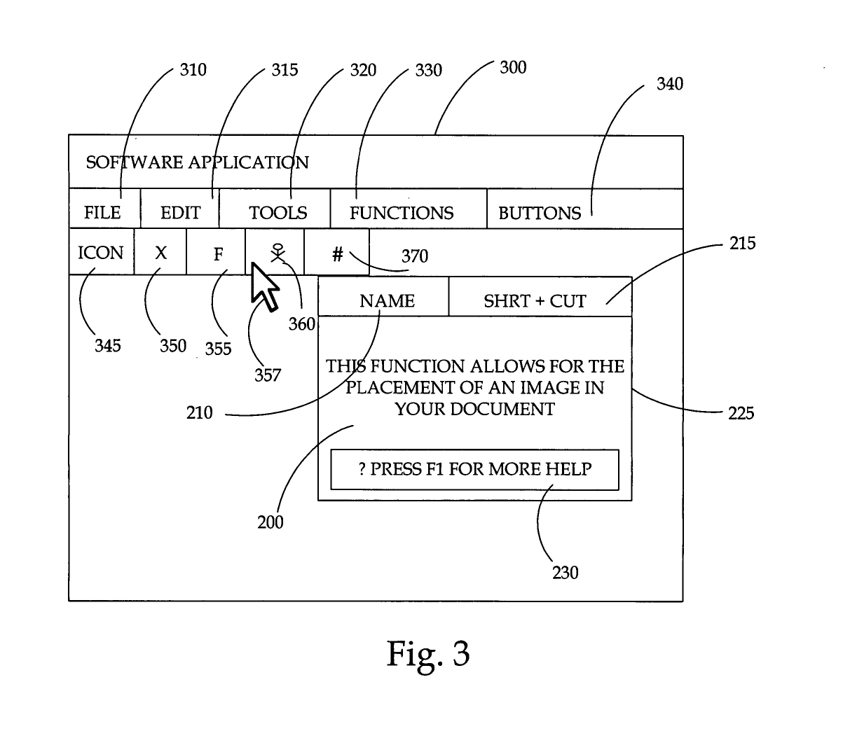

According to embodiments, each of the sections 215, 220, 225, 230 displayed in the user interface element 200, described above, are optional. That is, the user interface element 200 may contain one, all or different combinations of the sections 210, 215, 220, 225, 230. For example, a given user interface element 200 may include a title section 210 and a shortcut section 215 only. For another example, a given user interface element 200 may include a title section 210 and a description section 225 only. For another example, a given user interface element 200 may include a title section 210 and a footer section 230. Moreover, placement of the various sections 210-230 in the user interface element 200 may be varied according to the desires of the developer of the user interface element 200. The user interface element 200, shown in FIG. 3, illustrates a user interface element without an image 220.

FIG. 3 illustrates the user interface element of FIG. 2 displayed near a focused-on button in an illustrative software application user interface. An example user interface 300 of a software application, for example, a word processing application, a spreadsheet application, a slide presentation application, and the like, is illustrated having one or more rows of functionality buttons or controls in which are arranged one or more selectable functionality controls. For example, a file control 310, an edit control 315, a tools control 320, a functions control 330 and a buttons control 340 are provided in a first row of selectable buttons or controls. A second row of selectable buttons or controls includes an icon control 345, an X control 350, an F control 355, an icon control 360, and an icon control 370.

As should be appreciated by those skilled in the art, some of the selectable buttons or controls, for example, the controls 345, 350, 355, 365, 370 may include non-textual icons, colors, figures or symbols associated with an underlying functionality. For example, the selectable button or control 360 includes an image icon, which may be selected for placement of an image in a document. As should be appreciated, the selectable buttons or controls shown in FIG. 3 are for purposes of illustration only and are not illustrative of the buttons or controls available for a particular software application.

Often a given icon, color, symbol, or other figure applied to a selectable button or control does not provide enough information to allow a user to fully appreciate the attributes of the associated functionality or to appreciate what will happen to an associated document or object if the associated functionality is invoked. Even if a given selectable button or control contains a text-based identifier, for example, the word “File,” as illustrated for the control 310, a user may still be left with insufficient information as to the nature of the associated functionality. As described above with reference to FIG. 2, according to embodiments of the present invention, if a given button or control is focused on, for example, by placement of the mouse pointer 357 on a desired button or control, the user interface element 200 is automatically deployed for providing helpful contextual information about the associated functionality.

As illustrated in FIG. 3, the mouse pointer 357 is hovered over the button 360. According to one embodiment, the user interface element 200 may be deployed automatically upon hovering the mouse pointer over the desired button, or the user interface element 200 may be deployed after a slight delay, for example, 900 milliseconds. According to embodiments, the user interface element 200 may be dismissed in response to a number of actions. For example, if the subject button 360 is selected, for example, by mouse click, the user interface element 200 is dismissed. For another example, if the mouse pointer is hovered away from the subject button 360, the user interface element 200 is dismissed. On the other hand, according to one embodiment, once the user interface element 200 is deployed, the user interface element remains deployed as long as the mouse pointer is positioned over the subject button or control even if the mouse pointer is moved within the area in which the subject button or control is displayed. That is, the user interface element 200 will remain displayed until the mouse pointer is moved away from the subject button or control. For another dismissal example, any keyboard event may cause dismissal of the user interface element 200. As should be appreciated, some keyboard events, for example, shift, control, caps lock, or others may be designated for not dismissing the user interface element 200 if it is desired that those keyboard events should be allowed without dismissing the user interface element 200. According to one embodiment, the user interface element 200 may be automatically dismissed after a given delay, for example, a 20,000 millisecond delay.

According to embodiments of the present invention, the user interface element 200 is positioned in horizontal alignment with the focused on button or control. For example the element 200 may be aligned to the left (or right) border of the focused-on button or control. Alternatively, the user interface element 200 may be positioned in horizontal alignment with the focus device, for example, mouse pointer tip. That is, the horizontal orientation of the user interface element 200 is aligned to the right or to the left with the tip of the mouse pointer 357, as illustrated in FIG. 3. According to one embodiment, the vertical position of the user interface element 200 may be set to a particular number of pixels below the tip of the mouse pointer so that the user interface element 200 does not conflict with the display of the associated button or control. For example, the tip of the mouse pointer 357 may be positioned in an upper portion of the subject button or control 360. Thus, by positioning the user interface element 200 a set distance, for example, 20 pixels, beneath the tip of the mouse pointer 357, the display of the user interface element 200 will not cover the subject button 360 from view.

According to one embodiment, the user interface element 200 may be displayed in a position beneath the lowest row of selectable buttons or controls displayed in the rows of buttons or controls in the user interface 300. For example, if the mouse pointer 357 is focused on the functions control 330, illustrated in FIG. 3, the user interface element 200 may be nonetheless displayed in a position beneath the second row of selectable buttons or controls 345, 350, 355, 360, 370 so that the display of the user interface element 200 does not cover any of the displayed selectable buttons or controls.

As described herein a user interface element is deployed near a focused-on button or control for providing an identification of an associated functionality and for providing display space for additional content such as help information and explanatory information related to the associated functionality. It will be apparent to those skilled in the art that various modifications or variations may be made in the present invention without departing from the scope or spirit of the invention. Other embodiments of the present invention will be apparent to those skilled in the art from consideration of the specification and practice of the invention disclosed herein.

We claim:

1. An user interface element for providing information about a focused-on user interface control, comprising:
a display space for deploying in proximity to a focused-on user interface control;
a title field disposed in the display space for displaying a title of a functionality associated with the focused-on user interface control;
a shortcut field disposed in the display space for displaying a keyboard shortcut for invoking a functionality associated with the focused-on user interface control; and
a description field disposed in the display space for displaying textual information about the focused-on user interface control.

2. The user interface element of claim 1, further comprising an image field disposed in the display space for displaying an image that is contextually relevant to the focused-on user interface control.

3. The user interface element of claim 1, further comprising a footer field disposed in the display space for displaying textual information about the focused-on user interface control.

4. The user interface element of claim 1, further comprising a footer field disposed in the display space for displaying a command for causing a display of help content in the description field, the help content being about a functionality associated with the focused-on user interface control.

5. The user interface element of claim 1, further comprising a footer field disposed in the display space for displaying a command for causing a display of help content in the footer field, the help content being about a functionality associated with the focused-on user interface control.

6. The user interface element of claim 1, further comprising a footer field for displaying a command for invoking a functionality associated with the focused-on user interface control.

7. An user interface element for providing information about a focused-on user interface control, comprising:
a display frame for deploying in proximity to a focused-on user interface control;
a title field disposed in an upper left corner of the display frame for displaying a title of a functionality associated with the focused-on user interface control;
a shortcut field disposed in an upper right corner of the display frame for displaying a keyboard shortcut for invoking a functionality associated with the focused-on user interface control; and
a description field disposed in the display frame beneath the title field and the shortcut field for displaying textual information about the focused-on user interface control.

8. The user interface element of claim 7, further comprising an image field disposed in the display frame adjacent to the description field for displaying an image that is contextually relevant to the focused-on user interface control.

9. The user interface element of claim 7, further comprising a footer field disposed in the display frame beneath the description field for displaying textual information about the focused-on user interface control.

10. The user interface element of claim 7, further comprising a footer field disposed in the display frame beneath the description field for displaying a command for causing a display in the description field of help content about a functionality associated with the focused-on user interface control.

11. The user interface element of claim 7, further comprising a footer field disposed in the display frame for displaying a command for causing a display in the footer field of help content about a functionality associated with the focused-on user interface control.

12. The user interface element of claim 7, further comprising a footer field disposed in the display frame beneath the description field for displaying a command for invoking a functionality associated with the focused-on user interface control.

13. A computer-readable medium on which is stored computer executable instructions which, when executed by a computer, perform a method for providing contextually relevant information about a focused-on user interface control, comprising:
receiving an indication of a focus on a user interface control;
upon receiving the indication of the focus on the user interface control, deploying a display frame in proximity to the focused-on user interface control;
upon receiving the indication of the focus on the user interface control, displaying in the display frame a title field and displaying in the title field a name of a functionality associated with the focused-on user interface control;
upon receiving the indication of the focus on the user interface control, displaying in the display frame a shortcut field, and displaying in the shortcut field a keyboard shortcut for invoking the functionality associated with the focused-on user interface control; and
upon receiving the indication of the focus on the user interface control, displaying in the display frame a description field, and displaying in the description field textual information about the focused-on user interface control.

14. The method of claim 13, further comprising upon receiving the indication of the focus on the user interface control, displaying an image field in the display frame, and displaying in the image field an image that is contextually relevant to the focused-on user interface control.

15. The method of claim 13, upon receiving the indication of the focus on the user interface control, displaying a footer field in the display frame, and displaying a command in the footer field for causing a display of help content about a functionality associated with the focused-on user interface control.

16. The method of claim 13, wherein deploying a display frame in proximity to the focused-on user interface control includes deploying the display frame such that the display frame does not cover from view any displayed user interface controls

17. The method of claim 13, wherein deploying the display frame in proximity to the focused-on user interface control upon receiving the indication of the focus on the user interface control includes deploying the display frame after a specified delay period after receiving the indication of the focus on the user interface control.

18. The method of claim 13, further comprising dismissing the display frame from view upon receiving a selection of the focused-on user interface control for invocation of a functionality associated with the focused-on user interface control.

19. The method of claim 13, further comprising dismissing the display frame from view upon receiving an indication that a focus has been removed from the focused-on user interface control.

20. The method of claim 13, further comprising dismissing the display frame from view after a specified delay period during which a focus is maintained on the focused-on user interface control.
